(19) United States
(12) Patent Application Publication
(10) Pub. No.: US 2025/0386114 A1
(43) Pub. Date: Dec. 18, 2025

(54) RANGE IMAGE GENERATION DEVICE AND EQUIPMENT

(71) Applicant: CANON KABUSHIKI KAISHA, Tokyo (JP)

(72) Inventors: TAKASHI OKAMURA, Tokyo (JP); KAZUMA CHIDA, Kanagawa (JP)

(21) Appl. No.: 19/237,782

(22) Filed: Jun. 13, 2025

(30) Foreign Application Priority Data
Jun. 14, 2024 (JP) 2024-096899

(51) Int. Cl. H04N 25/47; G01S 17/89; H04N 25/46; H04N 25/78

(52) U.S. Cl. CPC H04N 25/47; G01S 17/89; H04N 25/46; H04N 25/78

(57) ABSTRACT

A range image generation device is provided. The device includes an image generator to generate a range image based on outputs from pixels in each of ranging frame periods and an event detector. In each ranging frame period, sub-frames are acquired by detection operations in which time from a light emission timing until an exposure period is different. The event detector detects a change of a signal value in at least two ranging frame periods. In each ranging frame period, the image generator acquires a pixel value based on the sub-frames for a pixel for which the change is detected, and does not acquire a pixel value, or acquires the pixel value based on the sub-frames if a set condition is satisfied for a pixel for which no change is detected.

### BACKGROUND

### Field of the Technology

The present disclosure relates to a range image generation device and equipment.

### Description of the Related Art

There is known a ranging device using the Time of Flight (ToF) method that performs ranging by emitting light from a light source and detecting the light reflected by an object. In US-2017-0052065, distance measurement by a time-gating technique using a Single Photon Avalanche Diode (SPAD) sensor is described. In the time-gating technique, an object is repetitively irradiated with a laser beam at a predetermined frequency, a specific exposure period associated with the timing of laser beam irradiation is set for the SPAD sensor, and photon detection is performed in the exposure period. A wait time from laser beam irradiation to the exposure period is shifted, thereby acquiring the distance to the object based on the wait time until the exposure period in which photons are detected.

### SUMMARY

According to some embodiments, a range image generation device comprising a plurality of pixels each including a photoelectric conversion element, and an image generator configured to generate a range image based on outputs from the plurality of pixels in each of a plurality of ranging frame periods, wherein in each ranging frame period, a plurality of sub-frames are acquired by a plurality of detection operations in which time from a light emission timing of a light source until an exposure period for detecting light in the photoelectric conversion element is different, the range image generation device further comprises an event detector configured to detect, for each of the plurality of pixels, a change of a signal value in at least two ranging frame periods of the plurality of ranging frame periods, in each ranging frame period, for a pixel for which the change is detected by the event detector, the image generator is configured to acquire a pixel value of a range image based on the plurality of sub-frames, and in each ranging frame period, for a pixel for which no change is detected by the event detector, the image generator is configured not to acquire a pixel value of the range image, or is configured to acquire the pixel value of the range image based on the plurality of sub-frames if a set condition is satisfied, is provided.

Further features of the various embodiments will become apparent from the following description of embodiments with reference to the attached drawings. The following description of embodiments are described by way of example.

### BRIEF DESCRIPTION OF THE DRAWINGS

FIG. 1 is a hardware block diagram showing an example of the configuration of a range image generation device according to an embodiment;

FIG. 2 is a view showing an example of the configuration of the photoelectric conversion device of the range image generation device shown in FIG. 1;

FIG. 3 is a view showing an example of the configuration of the sensor board of the photoelectric conversion device shown in FIG. 2;

FIG. 4 is a view showing an example of the configuration of the circuit board of the photoelectric conversion device shown in FIG. 2;

FIG. 5 is a block diagram showing an example of the configuration of one pixel of the photoelectric conversion device shown in FIG. 2;

FIGS. 6A and 6B are views for explaining an example of the operation of an avalanche photodiode of the photoelectric conversion device shown in FIG. 2;

FIG. 7 is a functional block diagram showing an example of the configuration of the range image generation device shown in FIG. 1;

FIG. 8 is a view showing the drive timing of the range image generation device shown in FIG. 1;

FIG. 9 is a view for explaining a ranging frame, a sub-frame, and a micro-frame of the range image generation device shown in FIG. 1;

FIG. 10 is a flowchart showing an operation in range image generation of the range image generation device shown in FIG. 1;

FIG. 11 is a flowchart showing an operation in range image generation of the range image generation device shown in FIG. 1;

FIG. 12 is a view showing an example of the configuration of the circuit board of the photoelectric conversion device shown in FIG. 2;

FIG. 13 is a block diagram showing an example of the configuration of one pixel of the photoelectric conversion device shown in FIG. 2;

FIG. 14 is a functional block diagram showing an example of the configuration of the range image generation device shown in FIG. 1;

FIG. 15 is a view for explaining a ranging frame, a sub-frame, and a micro-frame of the range image generation device shown in FIG. 1;

FIG. 16 is a view for explaining a ranging frame, a sub-frame, and a micro-frame of the range image generation device shown in FIG. 1; and

FIG. 17 is a view showing an example of the configuration of equipment incorporating the range image generation device according to the embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

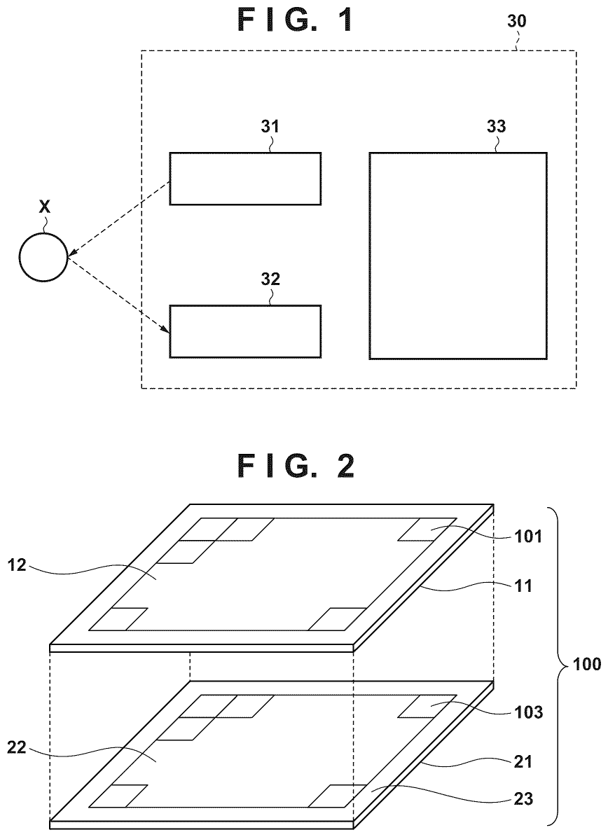

A range image generation device according to the embodiment of the present disclosure will be described with reference to FIGS. 1 to 16. FIG. 1 is a hardware block diagram schematically showing an example of the configuration of a range image generation device 30 according to this embodiment. The range image generation device 30 includes a light emitting device 31, a light receiving device 32, and a signal processing circuit 33. The configuration of the range image generation device 30 shown in this embodiment is merely an example, and the configuration is not limited to that shown in the drawings.

The range image generation device 30 is a device that measures the distance from the range image generation device 30 to a ranging target X using a technique such as Light Detection And Ranging (LiDAR). The range image generation device 30 measures the distance from the range image generation device 30 to the target X based on the time difference from light emission of the light emitting device 31 until the emitted light is reflected by the target X and received by the light receiving device 32. In addition, the range image generation device 30 can two-dimensionally measure the distance at a plurality of points by emitting a laser beam to a predetermined distance range including the target X and receiving reflected light by a pixel array. The range image generation device 30 can thus generate a range image and output it.

Light received by the light receiving device 32 includes not only reflected light from the target X but also ambient light such as sunlight. Hence, the range image generation device 30 performs ranging while suppressing the influence of ambient light using a method of measuring incident light in each of a plurality of periods (bin periods) and determining that reflected light enters during a bin period where the light amount reaches a peak.

The light emitting device 31 is a device functioning as a light source that emits light such as a laser beam to the outside of the range image generation device 30. The signal processing circuit 33 can include a processor that performs arithmetic processing of a digital signal, a memory that stores the digital signal, and the like. The memory can be, for example, a semiconductor memory such as an SRAM or a DRAM.

The light receiving device 32 generates a pulse signal including pulses based on incident light. The light receiving device 32 is a photoelectric conversion device including, for example, an avalanche photodiode (APD) as a photoelectric conversion element. In this case, if one photon enters the APD and a charge is generated, avalanche multiplication occurs, and one pulse is generated in accordance with an avalanche current. However, the light receiving device 32 may be a device using a photoelectric conversion element using another photodiode such as a PN diode or a PIN diode.

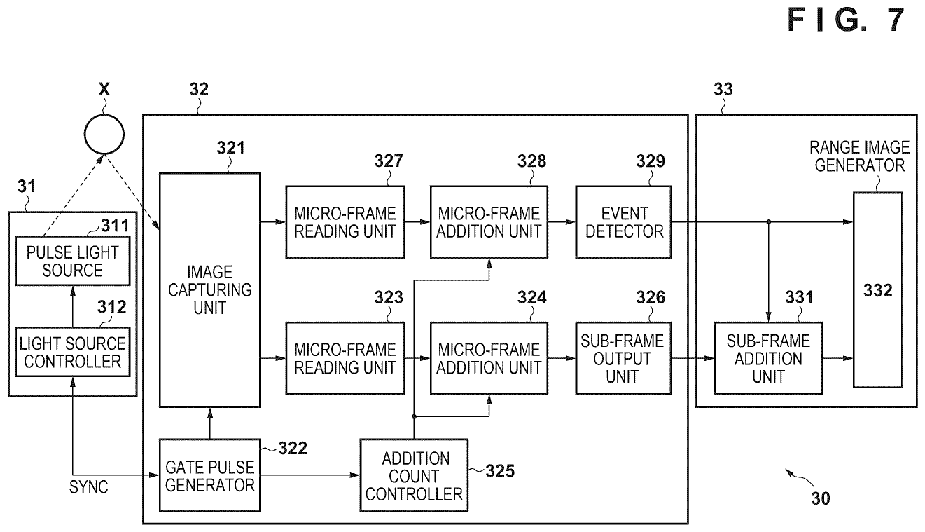

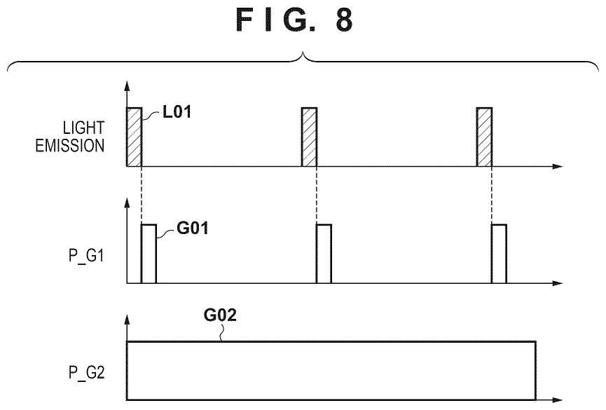

In this embodiment, the light receiving device 32 includes a pixel array in which a plurality of pixels each including a photoelectric conversion element are arranged in an array to form a plurality of rows and a plurality of columns. A photoelectric conversion device that is a detailed example of the configuration of the light receiving device 32 will be described here with reference to FIGS. 2 to 6A and 6B. The configuration of the photoelectric conversion device to be described below is merely an example. The photoelectric conversion device applicable to the light receiving device 32 is not limited to the device to be described below, and any device capable of implementing functions to be described later with reference to FIGS. 7 to 16 can be used.

FIG. 2 is a schematic view showing the overall configuration of a photoelectric conversion device 100 incorporated in the light receiving device 32 according to this embodiment. The photoelectric conversion device 100 includes a sensor board 11 and a circuit board 21, which are stacked on each other. The sensor board 11 and the circuit board 21 are electrically connected to each other. The sensor board 11 includes a pixel region 12 with a plurality of pixels 101 arranged to form a plurality of rows and a plurality of columns. The circuit board 21 includes a circuit region 22 with a plurality of pixel signal processors 103 arranged to form a plurality of rows and a plurality of columns, and a circuit region 23 arranged on the outer periphery of the circuit region 22. The circuit region 23 can include a circuit that controls the plurality of pixel signal processors 103, and the like. The sensor board 11 includes a light incident surface that receives incident light, and a connecting surface facing the light incident surface. The sensor board 11 is connected to the circuit board 21 on the connecting surface side. That is, the photoelectric conversion device 100 is a so-called backside irradiation type photoelectric conversion device.

The following description will be made assuming that the sensor board 11 and the circuit board 21 are diced chips. However, the sensor board 11 and the circuit board 21 are not limited to chips. For example, the sensor board 11 and the circuit board 21 may have a wafer shape. Also, if the sensor board 11 and the circuit board 21 are diced chips, the photoelectric conversion device 100 may be manufactured by stacking these in a wafer state and then performing dicing or by performing dicing and then stacking these.

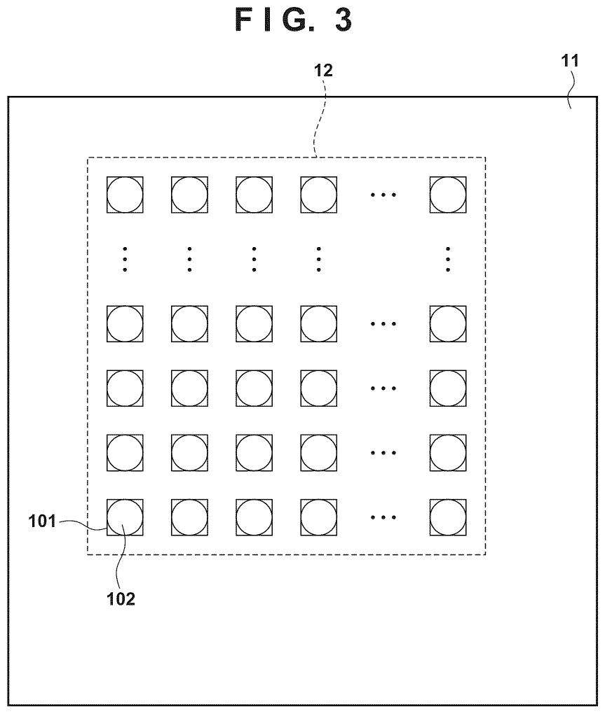

FIG. 3 is a schematic block diagram showing an example of the arrangement of the sensor board 11. The pixel region 12 includes the plurality of pixels 101 arranged to form a plurality of rows and a plurality of columns. Each of the plurality of pixels 101 includes, in the sensor board 11, a photoelectric converter 102 including an APD 201 as a photoelectric conversion element.

Of charge pairs generated by the APD, the conductivity type of charges used as signal charges will be referred to as a first conductivity type. The first conductivity type indicates a conductivity type having, as the majority carrier, charges of the same polarity as the signal charges. Also, a conductivity type opposite to the first conductivity type, that is, a conductivity type having, as the majority carrier, charges of a polarity different from the signal charges will be referred to as a second conductivity type. In the following explanation, the anode of the APD has a fixed potential, and a signal is extracted from the cathode of the APD. Hence, a semiconductor region of the first conductivity type is an n-type semiconductor region, and a semiconductor region of the second conductivity type is a p-type semiconductor region. However, the present disclosure is not limited to this, and the cathode of the APD may have a fixed potential, and a signal ma be extracted from the anode of the APD. In this case, a semiconductor region of the first conductivity type is a p-type semiconductor region, and a semiconductor region of the second conductivity type is an n-type semiconductor region. Also, a case where one node of the APD has a fixed potential will be described below, but the potentials of both nodes may vary.

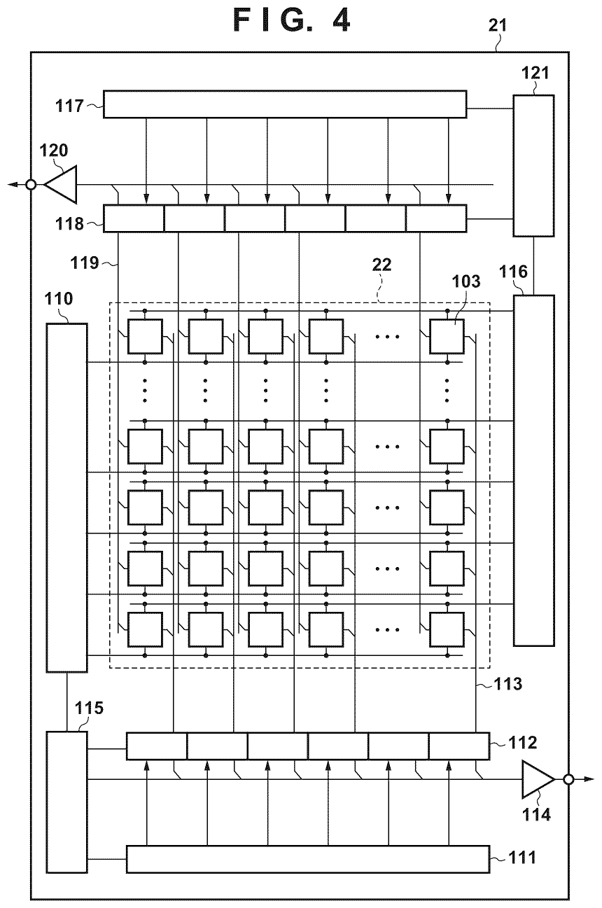

FIG. 4 is a schematic block diagram showing an example of the configuration of the circuit board 21. The circuit board 21 includes the circuit region 22 with the plurality of pixel signal processors 103 arranged to form a plurality of rows and a plurality of columns.

Also, on the circuit board 21, a vertical scanning circuit 110, a horizontal scanning circuit 111, a reading circuit 112, pixel output signal lines 113, an output circuit 114, and a control signal generator 115 are arranged. In addition, on the circuit board 21, a vertical scanning circuit 116, a horizontal scanning circuit 117, a reading circuit 118, pixel output signal lines 119, an output circuit 120, and a control signal generator 121 are arranged. The plurality of photoelectric converters 102 shown in FIG. 3 and the plurality of pixel signal processors 103 shown in FIG. 4 are electrically connected via connection wires each of which is provided for the basis of the pixel 101. In this embodiment, the pixel signal processor 103 is configured to output two types of signals of different exposure periods from the pixel 101.

The control signal generator 115 is a control circuit that generates control signals for driving the vertical scanning circuit 110, the horizontal scanning circuit 111, and the reading circuit 112 and supplies the control signals to these components. The control signal generator 115 thus controls the drive timings, and the like of these components. Additionally, the control signal generator 121 is a control circuit that generates control signals for driving the vertical scanning circuit 116, the horizontal scanning circuit 117, and the reading circuit 118 and supplies the control signals to these components. The control signal generator 121 thus controls the drive timings, and the like of these components.

The vertical scanning circuit 110 supplies a control signal to each of the plurality of pixel signal processors 103 based on the control signal supplied from the control signal generator 115. The vertical scanning circuit 110 supplies the control signal on a row basis to each pixel signal processor 103 via a drive line provided for each row of the circuit region 22. As will be described later, a plurality of drive lines can be arranged for each row. As the vertical scanning circuit 110, a logic circuit such as a shift register or an address decoder can be used. The vertical scanning circuit 110 thus selects a row to output signals from the pixel signal processors 103.

The vertical scanning circuit 116 supplies a control signal to each of the plurality of pixel signal processors 103 based on the control signal supplied from the control signal generator 121. The vertical scanning circuit 116 supplies the control signal on a row basis to each pixel signal processor 103 via a drive line provided for each row of the circuit region 22. As will be described later, a plurality of drive lines can be arranged for each row. As the vertical scanning circuit 116, a logic circuit such as a shift register or an address decoder can be used. The vertical scanning circuit 116 thus selects a row to output signals from the pixel signal processors 103.

A signal output from the photoelectric converter 102 of the pixel 101 is processed by the pixel signal processor 103. The pixel signal processor 103 counts the number of pulses output from the APD included in the photoelectric converter 102, thereby acquiring a digital signal having a plurality of bits and holding it.

The horizontal scanning circuit 111 supplies control signals to the reading circuit 112 based on the control signal supplied from the control signal generator 115. The pixel signal processors 103 are connected to the reading circuit 112 via the pixel output signal line 113 provided for each column of the circuit region 22. The pixel output signal line 113 of one column is shared by a plurality of pixel signal processors 103 of the corresponding column. The pixel output signal line 113 includes a plurality of wires. The pixel output signal line 113 has at least a function of outputting a digital signal from each pixel signal processor 103 to the reading circuit 112 and a function of supplying a control signal for selecting a column to output signals to the pixel signal processors 103. The reading circuit 112 outputs a signal to a storage unit or a signal processor outside the photoelectric conversion device 100 via the output circuit 114 based on the control signal supplied from the control signal generator 115.

The horizontal scanning circuit 117 supplies control signals to the reading circuit 118 based on the control signal supplied from the control signal generator 121. The pixel signal processors 103 are connected to the reading circuit 118 via the pixel output signal line 119 provided for each column of the circuit region 22. The pixel output signal line 119 of one column is shared by a plurality of pixel signal processors 103 of the corresponding column. The pixel output signal line 119 includes a plurality of wires. The pixel output signal line 119 has at least a function of outputting a digital signal from each pixel signal processor 103 to the reading circuit 118 and a function of supplying a control signal for selecting a column to output signals to the pixel signal processors 103. The reading circuit 118 outputs a signal to a storage unit or a signal processor outside the photoelectric conversion device 100 via the output circuit 120 based on the control signal supplied from the control signal generator 121.

In FIGS. 2 to 4, the photoelectric converters 102 are arranged in a form of a two-dimensional array in the pixel region 12, but the arrangement is not limited to this. The array of the photoelectric converters 102 in the pixel region 12 may be one-dimensional. Also, the pixel signal processors 103 need not always provided one for every pixel 101. For example, a plurality of pixels 101 may share one pixel signal processor 103. In this case, the pixel signal processor 103 sequentially processes signals output from the photoelectric converters 102, thereby providing a signal processing function to each pixel 101.

As shown in FIGS. 3 and 4, the circuit region 22 in which the plurality of pixel signal processors 103 are arranged is arranged in a region overlapping the pixel region 12 in a planar view. In a planar view, the vertical scanning circuit 110, the horizontal scanning circuit 111, the reading circuit 112, the output circuit 114, and the control signal generator 115 are arranged to overlap between the edges of the sensor board 11 and the edges of the pixel region 12. Similarly, the vertical scanning circuit 116, the horizontal scanning circuit 117, the reading circuit 118, the output circuit 120, and the control signal generator 121 are also arranged to overlap between the edges of the sensor board 11 and the edges of the pixel region 12. In other words, the sensor board 11 includes the pixel region 12 and a non-pixel region arranged around the pixel region 12. On the circuit board 21, the circuit region 23 in which the vertical scanning circuit 110, the horizontal scanning circuit 111, the reading circuit 112, the output circuit 114, and the control signal generator 115, and the vertical scanning circuit 116, the horizontal scanning circuit 117, the reading circuit 118, the output circuit 120, and the control signal generator 121 are arranged is arranged in a region overlapping the non-pixel region in a planar view.

The arrangement of the pixel output signal lines 113, the arrangement of the reading circuit 112, and the arrangement of the output circuit 114 are not limited to those shown in FIG. 4. For example, the pixel output signal lines 113 may be arranged extending in the row direction and shared by a plurality of pixel signal processors 103 of corresponding rows. The reading circuit 112 may be arranged to be connected to the pixel output signal lines 113 of each row.

Similarly, the arrangement of the pixel output signal lines 119, the arrangement of the reading circuit 118, and the arrangement of the output circuit 120 are not limited to those shown in FIG. 4. For example, the pixel output signal lines 119 may be arranged extending in the row direction and shared by a plurality of pixel signal processors 103 of corresponding rows. The reading circuit 118 may be arranged to be connected to the pixel output signal lines 119 of each row.

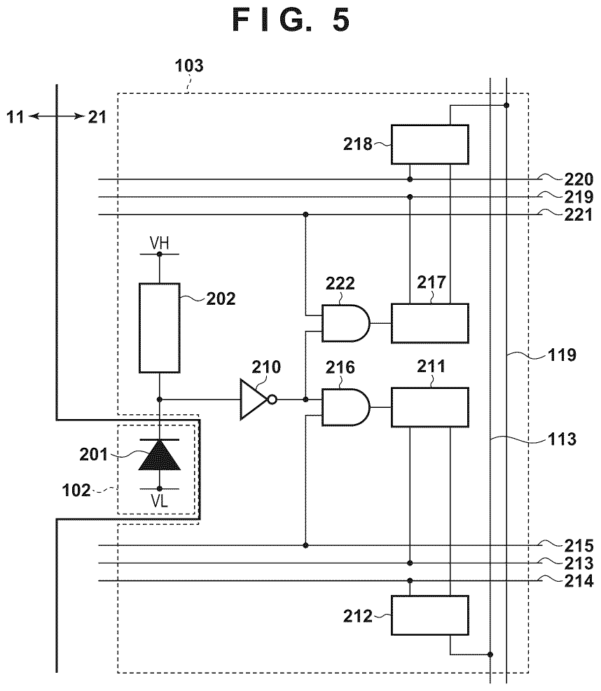

FIG. 5 is a schematic block diagram showing an example of the configuration of the photoelectric converter 102 and the pixel signal processor 103 corresponding to one pixel according to this embodiment. FIG. 5 schematically shows a configuration example more detailed than the above description, including the connection relationship between the photoelectric converter 102 arranged on the sensor board 11 and the pixel signal processor 103 arranged on the circuit board 21. In FIG. 5, the drive lines between the vertical scanning circuit 110 and the pixel signal processor 103 in FIG. 4 are shown as drive lines 213, 214, and 215. Similarly, the drive lines between the vertical scanning circuit 116 and the pixel signal processor 103 are shown as drive lines 219, 220, and 221.

The photoelectric converter 102 includes the APD 201. The pixel signal processor 103 includes a quenching element 202, a waveform shaper 210, a counter circuit 211, a selection circuit 212, and a gating circuit 216. The pixel signal processor 103 further includes a counter circuit 217, a selection circuit 218, and a gating circuit 222.

The APD 201 generates charges according to incident light by photoelectric conversion. A potential VL is applied to the anode of the APD 201. Also, the cathode of the APD 201 is connected to one main terminal of the quenching element 202 and the input terminal of the waveform shaper 210. A potential VH higher than the potential VL supplied to the anode is supplied to the cathode of the APD 201 via the quenching element 202. Thus, a reverse bias voltage that causes the APD 201 to perform an avalanche multiplication operation is supplied across the anode and the cathode of the APD 201. If charges are generated by incident light in the APD 201 to which the reverse bias voltage is supplied, the charges cause avalanche multiplication, and an avalanche current is generated.

Operation modes in a case where the reverse bias voltage is supplied to the APD 201 are a Geiger mode and a linear mode. The Geiger mode is a mode in which the operation is performed when the potential difference (voltage) between the anode and the cathode is larger than the breakdown voltage of the APD 201. The linear mode is a mode in which the operation is performed when the potential difference between the anode and the cathode is in the vicinity of or less than the breakdown voltage of the APD 201.

The APD 201 operated in the Geiger mode is called a Single Photon Avalanche Diode (SPAD). In this case, for example, the potential VL may be about −30 V, and the potential VH may be about 1 V. The APD 201 may be operated in the linear mode or in the Geiger mode. In a case of SPAD, the potential difference is large and the effect of avalanche multiplication is conspicuous as compared to the APD in the linear mode. For this reason, the APD 201 may be operated as an SPAD.

The quenching element 202 functions as a load circuit (quenching circuit) at the time of signal multiplication by avalanche multiplication. The quenching element 202 suppresses the voltage to be supplied to the APD 201 and suppresses avalanche multiplication (quenching operation). In addition, the quenching element 202 flows a current according to voltage drop by the quenching operation and returns the voltage to be supplied to the APD 201 to the potential VH (recharge operation). The quenching element 202 may be, for example, a resistance element.

The waveform shaper 210 shapes the potential change of the cathode of the APD 201 obtained upon detecting a photon and outputs a pulse signal. As the waveform shaper 210, for example, an inverter circuit is used. FIG. 5 shows an example in which one inverter is used as the waveform shaper 210. However, the present disclosure is not limited to this. The waveform shaper 210 may use a circuit formed by serially connecting a plurality of inverters or another circuit having a waveform shaping effect.

Each of the gating circuits 216 and 222 is a circuit that performs gating to pass a pulse signal output from the waveform shaper 210 only for a predetermined period. The input terminal of the gating circuit 216 and the input terminal of the gating circuit 222 are connected in parallel to the output terminal of the APD 201. During the period in which the pulse signal can pass through the gating circuit 216, a photon that enters the APD 201 is counted by the counter circuit 211 at the subsequent stage. Similarly, during the period in which the pulse signal can pass through the gating circuit 222, a photon that enters the APD 201 is counted by the counter circuit 217 at the subsequent stage. Hence, the gating circuits 216 and 222 each control a period in which signal generation based on incident light is performed in the pixel 101. The period in which the pulse signal can pass through the gating circuit 216 is controlled by a control signal supplied from the vertical scanning circuit 110 via the drive line 215. Similarly, the period in which the pulse signal can pass through the gating circuit 222 is controlled by a control signal supplied from the vertical scanning circuit 116 via the drive line 221.

FIG. 5 shows an example in which one AND circuit is used as each of the gating circuits 216 and 222. The pulse signal is input from the waveform shaper 210 to one of the two input terminals of the AND circuit that forms the gating circuit 216, and the control signal supplied from the vertical scanning circuit 110 is input to the other input terminal via the drive line 215. The AND circuit serving as the gating circuit 216 outputs the AND between these to the counter circuit 211. The pulse signal is input from the waveform shaper 210 to one of the two input terminals of the AND circuit that forms the gating circuit 222, and the control signal supplied from the vertical scanning circuit 116 is input to the other input terminal via the drive line 221. The AND circuit serving as the gating circuit 222 outputs the AND between these to the counter circuit 217. Here, the gating circuits 216 and 222 need only have a function of implementing the above-described gating, and a circuit configuration other than the AND circuit may be used.

The counter circuit 211 counts the pulse signal output from the waveform shaper 210 via the gating circuit 216 and holds a digital signal indicating a count value. Also, if the control signal is supplied from the vertical scanning circuit 110 via the drive line 213, the counter circuit 211 resets the held signal.

The counter circuit 217 counts the pulse signal output from the waveform shaper 210 via the gating circuit 222 and holds a digital signal indicating a count value. Also, if the control signal is supplied from the vertical scanning circuit 116 via the drive line 219, the counter circuit 217 resets the held signal.

To the selection circuit 212, a control signal is supplied from the vertical scanning circuit 110 shown in FIG. 4 via the drive line 214 shown in FIG. 5. In accordance with the control signal, the selection circuit 212 switches between electrical connection and non-connection between the counter circuit 211 and the pixel output signal line 113. The selection circuit 212 includes, for example, a buffer circuit configured to output a signal according to a value held by the counter circuit 211.

To the selection circuit 218, a control signal is supplied from the vertical scanning circuit 116 shown in FIG. 4 via the drive line 220 shown in FIG. 5. In accordance with the control signal, the selection circuit 218 switches between electrical connection and non-connection between the counter circuit 217 and the pixel output signal line 119. The selection circuit 218 includes, for example, a buffer circuit configured to output a signal according to a value held by the counter circuit 217. In the configuration shown in FIG. 5, the selection circuit 212 switches between electrical connection and non-connection between the counter circuit 211 and the pixel output signal line 113. Similarly, the selection circuit 218 switches between electrical connection and non-connection between the counter circuit 217 and the pixel output signal line 119. However, the method of controlling signal output to the pixel output signal lines 113 and 119 is not limited to this. For example, a switch such as a transistor may be arranged in a node between the quenching element 202 and the APD 201 or between the photoelectric converter 102 and the pixel signal processor 103. Signal output to the pixel output signal lines 113 and 119 may be controlled by switching between electrical connection and non-connection of the switch. Alternatively, signal output to the pixel output signal lines 113 and 119 may be controlled by changing the value of the potential VH or the potential VL supplied to the photoelectric converter 102 using a switch such as a transistor.

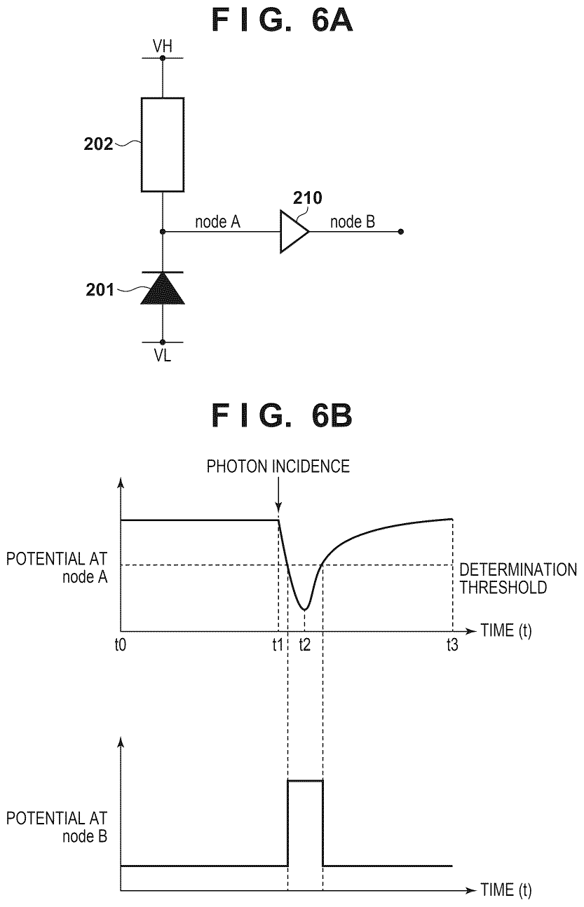

FIGS. 6A and 6B are views for explaining the operation of the APD 201 according to this embodiment. FIG. 6A shows the APD 201, the quenching element 202, and the waveform shaper 210 among the components shown in FIG. 5. As shown in FIG. 6A, the connection node between the APD 201, the quenching element 202, and the input terminal of the waveform shaper 210 is defined as a node A. Also, as shown in FIG. 6A, the output side of the waveform shaper 210 is defined as a node B.

FIG. 6B is a view showing a time-rate change of the potentials at the node A and the node B in FIG. 6A. During the period from time to t0 time t1, a voltage corresponding to (potential VH-potential VL) is applied to the APD 201 shown in FIG. 6A. If a photon enters the APD 201 at time t1, avalanche multiplication occurs in the APD 201. Thus, an avalanche current flows to the quenching element 202, and the potential at the node A drops. After that, the potential drop amount further increases, and the voltage applied to the APD 201 becomes gradually low. At time t2, avalanche multiplication in the APD 201 stops. Thus, the voltage level of the node A does not drop below a predetermined value. After that, during the period from time t2 to time t3, a current that compensates for the voltage drop amount flows from the node with the potential VH to the node A, and at time t3, the node A is statically settled to the original potential.

In the above-described process, during the period in which the potential at the node A is lower than a certain threshold, the potential at the node B has high level. In this way, the waveform of the drop of the potential at the node A caused by the incidence of photons is shaped by the waveform shaper 210 and output as a pulse to the node B.

The overall configuration and operation of the range image generation device 30 will be described next in more detail. FIG. 7 is a functional block diagram showing an example of the schematic configuration of the range image generation device 30 according to this embodiment. FIG. 7 shows more detailed configurations of the light emitting device 31, the light receiving device 32, and the signal processing circuit 33 explained with reference to FIG. 1.

The light emitting device 31 includes a pulse light source 311 and a light source controller 312. The pulse light source 311 is a light source such as a semiconductor laser device that emits pulse light to the entire ranging range. The pulse light source 311 may be a surface light source such as a surface emission laser. The light source controller 312 is a control circuit that controls the timing of light emission of the pulse light source 311.

The light receiving device 32 includes an image capturing unit 321, a gate pulse generator 322, a micro-frame reading unit 323, a micro-frame addition unit 324, an addition count controller 325, and a sub-frame output unit 326. The light receiving device 32 further includes a micro-frame reading unit 327, a micro-frame addition unit 328, and an event detector 329. As the image capturing unit 321, a photoelectric conversion device including the pixel region 12 in which pixel circuits each including the above-described APD 201 are two-dimensionally arranged may be used. The range image generation device 30 can thus acquire a two-dimensional range image.

The gate pulse generator 322 is a control circuit that outputs a control signal for controlling the drive timing of the image capturing unit 321. Also, the gate pulse generator 322 transmits/receives a control signal to/from the light source controller 312, thereby synchronously controlling the pulse light source 311 and the image capturing unit 321. Image capturing can thus be performed while controlling the time difference from the time of light emission from the pulse light source 311 to light reception by the image capturing unit 321. In this embodiment, the gate pulse generator 322 performs global gate driving of the image capturing unit 321. Global gate driving is a driving method of simultaneously performing incident light detection during the same exposure period in all the pixels 101 arranged in the image capturing unit 321 based on the emission time of pulse light from the pulse light source 311 as a reference. In the global gate driving according to this embodiment, incident light detection is repetitively performed while sequentially shifting timing from light emission to one-shot exposure. The pixels 101 arranged in the image capturing unit 321 thus simultaneously generate a 1-bit signal indicating the presence/absence of an incident photon in each of a plurality of exposure periods. The generated 1-bit signals can be held by the counter circuits 211 and 217. In this case, the counter circuits 211 and 217 are each formed by a 1-bit counter (memory circuit). Hence, the counter circuits 211 and 217 can each be called a memory circuit.

The global gate driving is implemented by inputting a signal of high level to the input terminals of the gating circuits 216 and 222 of each pixel 101 during a gating period based on a control signal supplied from the gate pulse generator 322. In this embodiment, a description will be made below assuming that the counter circuit 211 holds a signal for acquiring data for range image generation, and the counter circuit 217 holds a signal for acquiring data for event detection. Hence, the gate pulse generator 322 according to this embodiment generates gate pulses indicating different exposure periods to the gating circuits 216 and 222. A detailed example will be described with reference to FIG. 8. FIG. 8 is a drive timing chart showing the timing of a gate pulse according to this embodiment.

“Light emission” in FIG. 8 indicates the light emission timing of the pulse light source 311. As shown in FIG. 8, the pulse light source 311 emits light at a predetermined period in accordance with the control of the light source controller 312. “P_G1” and “P_G2” indicate the input timings of a plurality of types of gate pulses input from the gate pulse generator 322 to the image capturing unit 321. “P_G1” corresponds to a control signal input to the gating circuit 216 via the drive line 215 in FIG. 5. “P_G2” corresponds to a control signal input to the gating circuit 222 via the drive line 221 in FIG. 5.

Concerning the gating circuit 216 connected to the counter circuit 211, a gate pulse G01 is input at a timing synchronized with a light emission timing L01. Concerning the gating circuit 222 connected to the counter circuit 217, a gate pulse G02 is input during a predetermined exposure period in which image capturing is performed. As described above, by making the timings of the gate pulses G01 and G02 different, range information is obtained by the counter circuit 211 for each pixel 101 arranged in the image capturing unit 321, and brightness information for event detection is obtained by the counter circuit 217.

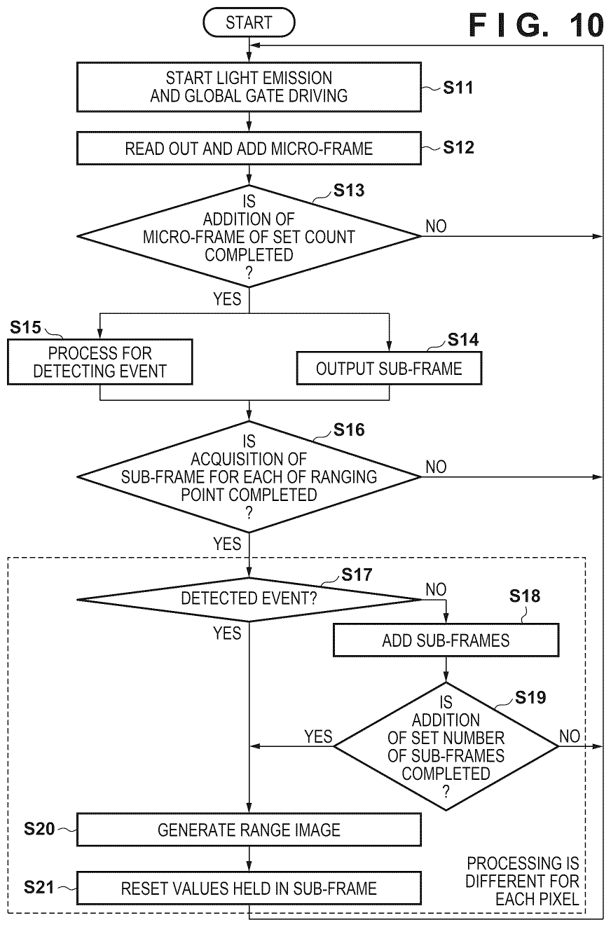

The micro-frame reading unit 323, the micro-frame addition unit 324, the addition count controller 325, the micro-frame reading unit 327, and the micro-frame addition unit 328 function as a reading unit that reads out a 1-bit signal forming a micro-frame from the image capturing unit 321. Furthermore, these circuits are signal processing circuits that perform predetermined signal processing for the readout 1-bit signal. Details of the operations of these components will be described later with reference to the flowchart of FIG. 10.

The sub-frame output unit 326 is an interface that outputs a signal of a predetermined standard from the light receiving device 32 to the signal processing circuit 33. The sub-frame output unit 326 transmits a signal from a memory in the light receiving device 32 to a memory in the signal processing circuit 33.

The event detector 329 detects, for each of the plurality of pixels 101, a change of a signal value in at least two ranging frame periods among a plurality of ranging frame periods. More specifically, the event detector 329 detects, for each pixel 101, an event from signal values obtained by at least two or more ranging frames acquired from the micro-frame addition unit 328, and outputs event information to the signal processing circuit 33. For example, if the signal value difference between continuous nth and (n+1)th frames exceeds a predetermined threshold for each pixel 101, the event detector 329 outputs an event detection signal for each pixel 101. The event detection signal is, for example, a binary signal. Here, the event detection need not always be performed between two continuous frames. For example, the event detection signal may be generated based on whether the signal value difference between the nth and (n+2)th frames exceeds a predetermined threshold.

The signal processing circuit 33 includes a sub-frame addition unit 331 and an image generator 332. The signal processing circuit 33 can be a computer including a processor that operates as the image generator 332, and a memory that operates as the sub-frame addition unit 331. The image generator 332 is a range image generator that generates a range image based on the outputs from the plurality of pixels 101 in each of a plurality of ranging frame periods. The operations of these components will also be described later with reference to the flowchart of FIG. 10.

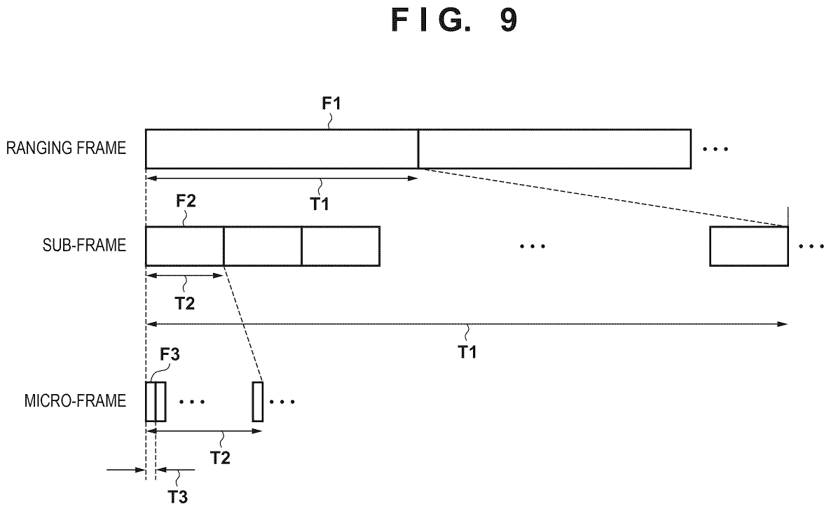

Next, before the explanation of a range image generation procedure according to this embodiment, the configurations of a ranging frame, a sub-frame, and a micro-frame will be described with reference to FIG. 9. FIG. 9 schematically shows the acquisition periods of a ranging frame corresponding to the data of a range image, a sub-frame used to generate the ranging frame, and a micro-frame used to generate the sub-frame by arranging blocks in the lateral direction. The lateral direction in FIG. 9 indicates the elapse of time, and one block indicates the acquisition period of one ranging frame, one sub-frame, or one micro-frame.

A ranging frame F1 corresponds to the data of one range image. That is, the ranging frame F1 has information corresponding to the distance to the target X, which is acquired, for each of the plurality of pixels 101, from the time difference from light emission to light reception. The information corresponding to the distance to the target X may be information calculated by performing various kinds of arithmetic processing for information corresponding to the distance from each of the plurality of pixels 101 to the target X. In this embodiment, it is assumed that a range image is acquired as a moving image, and acquisition of one ranging frame F1 is repetitively performed every time one ranging frame period T1 elapses. Thus, a range image is generated based on the outputs from the plurality of pixels 101 in each of a plurality of ranging frame periods T1.

One ranging frame F1 is generated from a plurality of sub-frames F2. One ranging frame period T1 includes a plurality of sub-frame periods T2. Every time one sub-frame period T2 elapses, acquisition of one sub-frame F2 is repetitively performed. The sub-frame F2 is formed by a multiple-bit signal corresponding to the amount of light that enters during the sub-frame period T2.

One sub-frame F2 is generated from a plurality of micro-frames F3. One sub-frame period T2 includes a plurality of micro-frame periods T3. Every time one micro-frame period T3 elapses, acquisition of one micro-frame F3 is repetitively performed. The micro-frame F3 is formed by a 1-bit signal indicating the presence/absence of incident light to the photoelectric conversion element (APD 201) during the micro-frame period T3. One sub-frame F2 of multiple-bit signal is generated by adding and compositing a plurality of micro-frames F3 of 1-bit signal. Thus, one sub-frame F2 can include a multiple-bit signal corresponding to the number of micro-frames F3 for which incident light is detected during the sub-frame period T2.

Also, each sub-frame F2 of multiple-bit signal may be generated by adding and compositing a plurality of micro-frames F3 across a plurality of ranging frames F1. An operation of generating one sub-frame F2 will sometimes be referred to as a detection operation hereinafter. In each ranging frame period T1, a plurality of sub-frames F2 are acquired by a plurality of detection operations in which the time from the light emission timing of the pulse light source 311 that is the light source until the exposure period for detecting light in the photoelectric conversion element (APD 201) is different. Details will be described later with reference to the flowchart of FIG. 10.

The plurality of sub-frames F2 for which the period from the light emission timing of the pulse light source 311 until incident light detection is different are thus acquired. The signal acquisition time in the period from the light emission timing of the pulse light source 311 to incident light detection can be associated with the distance from the range image generation device 30 to the ranging target. The signal acquisition time in which the signal value is maximized can be decided based on the distribution of the signal acquisition times and signal values in the plurality of sub-frames F2. Since it is estimated that reflected light has entered the image capturing unit 321 during the time in which the signal value is maximum, the distance can be acquired by converting the signal acquisition time in which the signal value is maximum into the distance to the target X. In addition, a range image can be generated by acquiring the distance for each pixel 101 and acquiring the two-dimensional distribution of distances.

As shown in FIG. 9, the length of the ranging frame period T1 necessary for acquiring one ranging frame F1 depends on the length of the sub-frame period T2 necessary for acquiring one sub-frame F2, and the length of the sub-frame period T2 depends on the number of micro-frames F3. The larger the number of micro-frames F3 is, the larger the noise reduction effect is. For this reason, the ranging accuracy and the frame rate hold a tradeoff relationship with respect to the number of micro-frames.

FIG. 10 is a flowchart showing an operation in range image generation of the range image generation device 30. An operation according to this embodiment will be described with reference to the flowchart of FIG. 10.

In the flowchart shown in FIG. 10, a series of processes in the loop from step S11 to step S13 indicates processing performed in the micro-frame period T3 in which one micro-frame F3 is acquired in FIG. 9. A series of processes in the loop from step S11 to step S16 indicates processing performed in the sub-frame period T2 in which one sub-frame F2 is acquired in FIG. 9. A series of processes in the loop from step S11 to step S19 and the loop from step S11 to step S21 indicates processing performed in the ranging frame period T1 in which one ranging frame F1 is acquired in FIG. 9.

In step S11, the light source controller 312 controls the pulse light source 311 to emit pulse light to a predetermined ranging range. In synchronism with this, the gate pulse generator 322 controls the image capturing unit 321 and causes it to start detection of incident light by global gate driving. Here, the gate pulse generator 322 generates gate pulses indicating different detection periods, as described with reference to FIG. 8, for the gating circuits 216 and 222. The gate pulse generator 322 supplies the gate pulse to the gating circuit 216 such that a plurality of detection operations in which the time (signal acquisition time) from the light emission timing of the pulse light source 311 until the exposure period for detecting light in the photoelectric conversion element (APD 201) is different are performed. Also, the gate pulse generator 322 supplies the gate pulse to the gating circuit 222 such that an event detection operation of acquiring a signal from the photoelectric conversion element (APD 201) is performed in an exposure period whose length is different from that of the exposure period of the detection operation. As shown in FIG. 8, the exposure period (gate pulse G02) of the event detection operation may be longer than the exposure period (gate pulse G01) of the detection operation. The event detector 329 detects a change of the signal value of each pixel 101 based on a signal obtained by the event detection operation.

Next, in step S12, the micro-frame reading units 323 and 327 each read out the micro-frame F3 from the image capturing unit 321 every time the micro-frame period T3 elapses. The micro-frame reading unit 323 reads out a 1-bit signal forming the micro-frame F3, which is held by the counter circuit 211. The micro-frame reading unit 327 reads out a 1-bit signal forming the micro-frame F3, which is held by the counter circuit 217. The readout micro-frames are held in the memories of the micro-frame addition units 324 and 328. The memories have a storage capacity capable of holding multiple-bit data for each pixel 101. Every time the micro-frame F3 is read out, the micro-frame addition units 324 and 328 each sequentially add the value of the micro-frame F3 to the value held in the memory. The micro-frame addition units 324 and 328 each thus add the plurality of micro-frames F3 in the sub-frame period T2 and acquire the sub-frame F2. The micro-frame reading unit 323 and the micro-frame addition unit 324 thus function as a reading unit that reads out the signal of the detection operation for range image generation. Similarly, the micro-frame reading unit 327 and the micro-frame addition unit 328 function as a reading unit that reads out the signal of the event detection operation for event detection. Also, the detection operation and the event detection operation may be performed in parallel.

Addition counts in the micro-frame addition units 324 and 328 are controlled by the addition count controller 325. For this control, the addition count controller 325 holds information of a preset addition count. The addition counts in the micro-frame addition units 324 and 328 may be the same or different. As described above, the micro-frame reading units 323 and 327 function as an acquisition unit that acquires the micro-frame F3 formed by a 1-bit signal based on incident light to the photoelectric conversion element (APD 201). Also, the micro-frame addition units 324 and 328 function as a composition unit that composites the plurality of micro-frames F3 acquired in different periods. For example, if the addition count is 16, 16 micro-frames F3 are added and composited, thereby generating a signal of the sub-frame F2 having 4-bit tones.

In step S13, the micro-frame addition units 324 and 328 each determine whether addition of the micro-frame F3 of a preset count is completed. If addition of the micro-frame F3 of the set count is not completed (NO in step S13), the process returns to step S11, and the next micro-frame F3 is read out. If addition of the micro-frame F3 of the set count is completed (YES in step S13), the process advances to step S14.

Next in step S14, the sub-frame output unit 326 reads out the sub-frame F2 whose addition is completed from the memory of the micro-frame addition unit 324, and outputs it to the sub-frame addition unit 331. The sub-frame addition unit 331 holds, in the memory, the sub-frame F2 output from the sub-frame output unit 326. The sub-frame addition unit 331 is configured to individually store the plurality of sub-frames F2 used to generate one ranging frame F1 for each pixel 101 and for each sub-frame period T2.

In step S15 that can be performed in parallel to step S14, the event detector 329 reads out the sub-frame F2 for which addition is completed from the memory of the micro-frame addition unit 328 and holds it in the memory of the event detector 329. As described above, the event detector 329 compares the signal value of each pixel 101 between two or more ranging frame periods T1, thereby outputting event information to the signal processing circuit 33.

In step S16, the signal processing circuit 33 determines whether the sub-frame addition unit 331 completes acquisition of the sub-frames F2 in a predetermined number (that is, the number of ranging points). If acquisition of the sub-frames F2 as many as the number of ranging points is not completed (NO in step S16), the process returns to step S11, and acquisition and addition of a plurality of micro-frames F3 are performed again to read out the next sub-frame F2. At this time, the time from the light emission timing of the pulse light source 311 to the start time of global gate driving for performing exposure is shifted (gate-shifted) with respect to the immediately preceding sub-frame period T2, and processing of acquiring each micro-frame F3 is performed. If acquisition of the sub-frames F2 as many as the number of ranging points is completed (YES in step S16), the process advances to step S17. By the loop from step S11 to step S16, the sub-frames F2 as many as the number of ranging points are acquired.

In step S17, the signal processing circuit 33 determines, for each pixel 101 based on the event information from the event detector 329, whether an event is detected. For a pixel for which no event is detected (NO in step S17), the process advances to step S18. For a pixel for which an event is detected (YES in step S17), the process advances to step S20.

In step S18, the sub-frame addition unit 331 sequentially adds the plurality of sub-frames F2 acquired from the sub-frame output unit 326 to the value held for each sub-frame period T2. It can be said that the sub-frame addition unit 331 holds the plurality of sub-frames F2 of the pixels 101 for which the event detector 329 detects no change in each ranging frame period T1, and if the event detector 329 detects no change in the continuous ranging frame periods T1, adds the plurality of sub-frames F2 in the continuous ranging frame periods T1, which are held for each pixel 101, for each sub-frame period T2. The maximum addition count is set in advance. For example, if the addition count is 4, four sub-frames of 4-bit tones generated by the micro-frame addition unit 324 are added and composited (addition and composition of 16 micro-frames F3). It is therefore possible to generate a frame signal of 6-bit tones at maximum (addition and composition of 64 micro-frames). Addition of the sub-frames F2 may be performed by the light receiving device 32. In this case, the sub-frame addition unit 331 functions as a storage unit that holds the added data of the sub-frames F2 output from the sub-frame output unit 326.

In step S19, the signal processing circuit 33 determines whether addition of every sub-frame of a preset count is completed. If addition of every sub-frame of the preset count is not completed (NO in step S19), the process returns to step S11, and acquisition and addition of a plurality of micro-frames F3 are performed again to read out the next ranging frame F1. In this case, the start time of global gate driving with respect to the light emission timing is reset to the first sub-frame period T2, and similar processing is performed. If addition of every sub-frame F2 of the set count is completed (YES in step S19), the process advances to step S20.

In step S20, the image generator 332 acquires the plurality of sub-frames F2 in one ranging frame period T1 from the sub-frame addition unit 331. The image generator 332 acquires a distance corresponding to a sub-frame with the maximum signal value for each pixel 101, thereby generating a range image indicating the two-dimensional distribution of distances. At this time, for the pixel 101 for which an event is detected by the event detector 329, in other words, for the pixel 101 for which a change of the signal value is detected in the ranging frame period T1, the image generator 332 acquires the pixel value of the range image corresponding to the distance based on the plurality of sub-frames F2. In this embodiment, the image generator 332 acquires the pixel value of the range image based on the plurality of sub-frames F2 in the ranging frame period T1 in which an event is detected by the event detector 329.

On the other hand, in step S20, for a pixel for which the event detector 329 does not detect an event, the image generator 332 does not acquire the pixel value of the range image or acquires the pixel value of the range image based on the plurality of sub-frames if a set condition is satisfied. More specifically, for the pixel 101 for which no event is detected (NO in step S17) and addition of every sub-frame F2 is not completed (NO in step S19), the pixel value of the range image is not acquired, and the pixel value in the immediately preceding ranging frame period T1 is directly used for the range image. Also, if the event detector 329 does not detect an event in a predetermined number of continuous ranging frame periods T1 (NO in step S17 and YES in step S19), the image generator 332 acquires the pixel value of the range image based on the data added by the sub-frame addition unit 331. It can be said that for the pixel 101 for which no event is detected (NO in step S17) and addition of every sub-frame F2 is completed (YES in step S19), the pixel value of the range image is acquired. Hence, when acquiring, for example, a range image as a moving image, the number of times of acquiring a pixel value for each pixel 101 can be smaller than the number of the plurality of ranging frame periods T1 repetitively implemented. This is because if the event detector 329 detects no event and the set condition is not satisfied (addition of every sub-frame F2 is not completed), the image generator 332 does not acquire the pixel value of the range image. Then, the image generator 332 outputs the data of the range image to a device outside the signal processing circuit 33. The range image can be used to, for example, detect the environment around a vehicle. In addition, the image generator 332 may store the pixel value of the range image in the internal memory of the range image generation device 30. The pixel value of the range image stored in the memory can be used as, for example, the pixel value of the pixel whose pixel value of the range image is not acquired.

After the range image is generated, in step S21, the image generator 332 resets the data held in the sub-frame addition unit 331, which corresponds to the pixel 101 whose pixel value of the range image is acquired, and the addition count. After that, the process returns to step S11, and acquisition and addition of a plurality of micro-frames F3 are performed again to read out the next ranging frame F1. In this case, the start time of global gate driving with respect to the light emission timing of the pulse light source 311 is reset to the period of the first sub-frame F2, and similar processing is performed.

As described above, in this embodiment, for the pixel 101 for which an event is detected, the pixel value of the range image indicating the distance corresponding to the time from light irradiation of the pulse light source 311 to light detection is acquired, and the pixel value of the range image is updated. On the other hand, for the pixel 101 for which no event is detected, the pixel value of the range image is not acquired until a preset condition is satisfied, more specifically, until a predetermined number of times of addition of sub-frames F2 are completed, and the sub-frame F2 is added. Since the pixel values are thus updated in each ranging frame period T1 for a region including a moving body whose amount of light entering the photoelectric conversion element (APD 201) changes, blurs can be suppressed without lowering the frame rate. In addition, when the pixel values are generated using the sub-frames F2 obtained in a plurality of ranging frame periods T1 for a region including a still object or background whose amount of light entering the photoelectric conversion element (APD 201) does not change, noise is reduced, and the ranging accuracy is improved. As described above, the range image generation device 30 according to this embodiment can improve both the frame rate and the ranging accuracy.

Here, the voltage (potential VH-potential VL) applied to the APD 201 may be configured to be controlled for each pixel 101 or each pixel region formed by a plurality of pixels 101. In this case, the voltage is controlled for the pixel 101 or pixel region for which no event is detected, thereby implementing power saving.

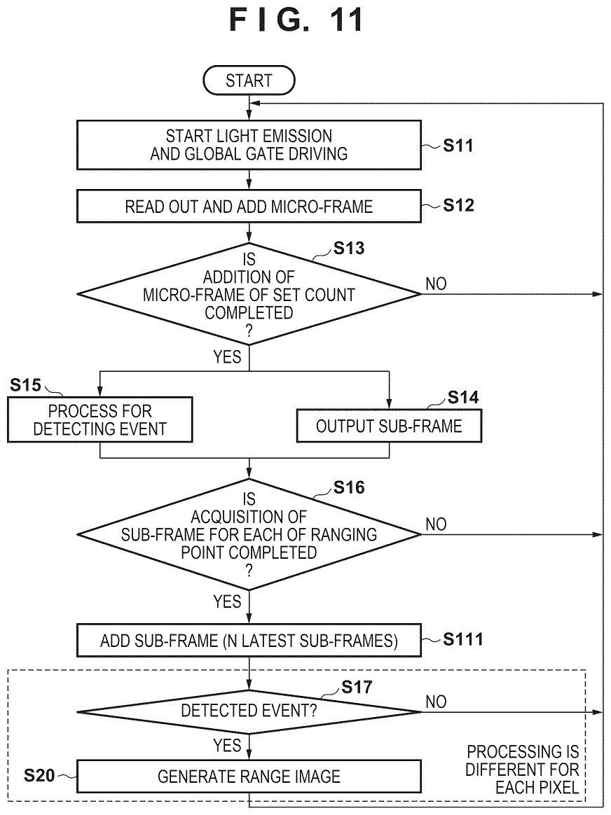

An example different from the processing procedure of range image generation shown in FIG. 10 will be described next with reference to FIG. 11. A description of components or procedures that can be the same as in the above-described embodiment will appropriately be omitted or simplified.

FIG. 11 is a flowchart showing an operation in range image generation of the range image generation device 30. An operation according to this embodiment will be described with reference to the flowchart of FIG. 11. In the flowchart shown in FIG. 11, processing until the sub-frames F2 as many as the number of ranging points are acquired by the loop from step S11 to step S16 is the same as the procedure shown in FIG. 10. If acquisition of the sub-frames F2 as many as the number of ranging points is completed in step S16, the process advances to step S111.

In step S111, the sub-frame addition unit 331 adds N latest sub-frames F2 of the plurality of sub-frames F2 acquired from the sub-frame output unit 326 for each pixel 101 and for each sub-frame period T2. It can be said that in each ranging frame period T1, the sub-frame addition unit 331 adds, for each sub-frame period T2, a plurality of sub-frames F2 in each of a predetermined number of (N) ranging frame periods T1 held for each pixel 101. N indicating the addition count of sub-frames is set in advance. For example, if the addition count is 4, as described above, a frame signal of 6-bit tones can be generated (addition and composition of 64 micro-frames). In this embodiment, the sub-frame addition unit 331 is configured to store N sub-frames of the plurality of sub-frames F2 used to generate one ranging frame F1 individually for each sub-frame period T2.

In step S17, like the procedure shown in FIG. 10, the signal processing circuit 33 determines, for each pixel 101 based on the event information from the event detector 329, whether an event is detected. For the pixel 101 for which no event is detected (NO in step S17), the process returns to step S11, and acquisition and addition of a plurality of micro-frames F3 are performed again to read out the next ranging frame. In this case, the start time of global gate driving with respect to the light emission timing is reset to the first sub-frame period T2, and similar processing is performed. For the pixel 101 for which an event is detected (YES in step S17), the process advances to step S20.

In step S20, the image generator 332 acquires, for the pixel for which a change is detected by the event detector 329, the pixel value of the range image based on the data added by the sub-frame addition unit 331. The image generator 332 acquires a distance corresponding to a sub-frame with the maximum signal value for each pixel, thereby generating the pixel value of a range image indicating the two-dimensional distribution of distances. Also, for the pixel 101 for which no event is detected (NO in step S17), the pixel value of the range image is not acquired, and the result of the immediately preceding ranging frame is directly used. After that, the process returns to step S11, and acquisition and addition of a plurality of micro-frames F3 are performed again to read out the next ranging frame F1. In this case, the start time of global gate driving with respect to the light emission timing is reset to the first sub-frame period T2, and similar processing is performed.

As described above, in this embodiment, for all the pixels 101, latest sub-frames of a plurality of sub-frames F2 in a predetermined preset number of ranging frame periods T1 are held by the sub-frame addition unit 331. For the pixel 101 for which an event is detected by the event detector 329, the image generator 332 acquires the pixel value of the range image based on the data added and held by the sub-frame addition unit 331. Thus, the pixel value of the pixel of the range image corresponding to the pixel 101 for which the event is detected is updated from the range image obtained in the immediately preceding ranging frame period T1. Thus, the preset maximum addition count is ensured for the data of the pixel 101, which is added and held by the sub-frame addition unit 331, and the influence of noise can be reduced in distance acquisition of the pixel 101 for which the event is detected. On the other hand, for the pixel 101 for which no event is detected by the event detector 329, the image generator 332 does not acquire the pixel value of the range image. Since the distance of the pixel 101 is not acquired until an event is detected, the processing load on the image generator 332 can be reduced.

Although not illustrated in the procedure of FIG. 11, in the first ranging frame period T1, the pixel values of the range image may be acquired for all the pixels 101 regardless of the presence/absence of event detection. Also, in the ranging frame periods T1 up to the (N−1)th time, the sub-frame addition unit 331 may acquire, using data obtained by adding a plurality of sub-frames F2 obtained in the (N−1)th ranging frame period T1, the pixel value of the range image for the pixel 101 for which an event is detected.

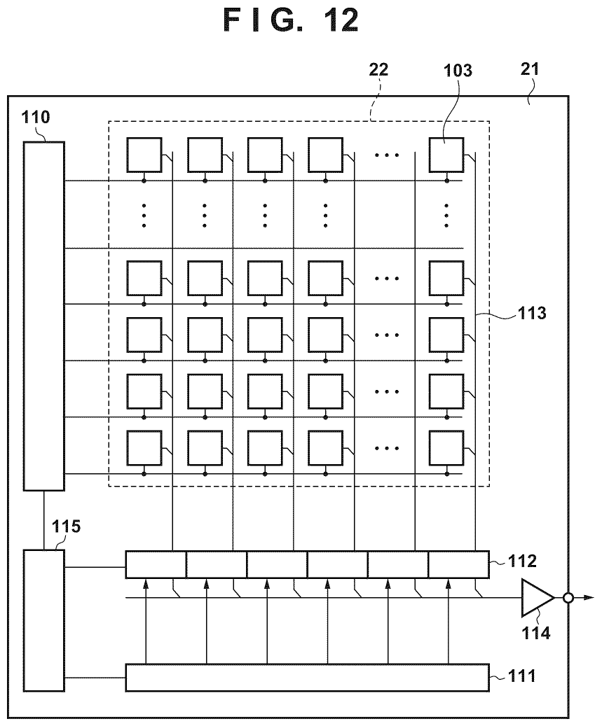

A modification of the above-described range image generation device 30 will be described next with reference to FIGS. 12 to 16. A description of components that can be the same as the above-described components will appropriately be omitted or simplified.

FIG. 12 is a schematic block diagram showing an example of the configuration of the circuit board 21 according to this embodiment. Unlike the circuit board 21 shown in FIG. 4, the circuit board 21 shown in FIG. 12 does not include the vertical scanning circuit 116, the horizontal scanning circuit 117, the reading circuit 118, the pixel output signal lines 119, the output circuit 120, and the control signal generator 121. Hence, in this embodiment, the pixel signal processor 103 is configured to output only one type of signal from the pixel 101. The rest of the configuration can be the same as the circuit board 21 shown in FIG. 4.

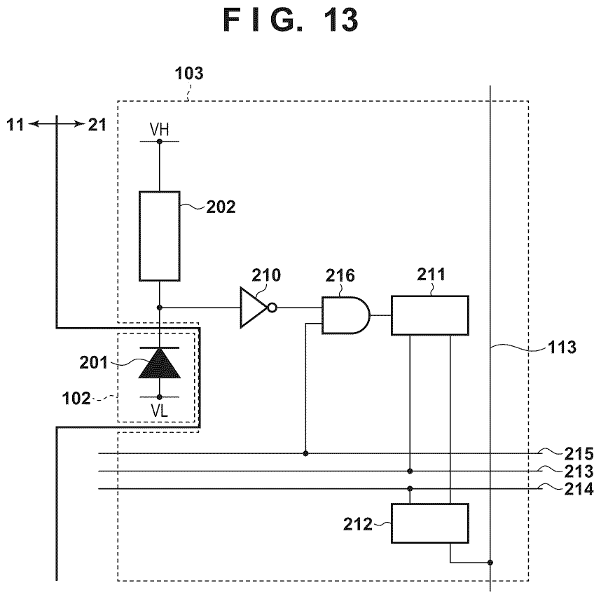

FIG. 13 is a schematic block diagram showing an example of the configuration of the photoelectric converter 102 and the pixel signal processor 103 corresponding to one pixel according to this embodiment. Unlike the pixel signal processor 103 shown in FIG. 5, the pixel signal processor 103 shown in FIG. 13 does not include the vertical scanning circuit 116, the drive lines 219, 220, and 221, the counter circuit 217, the selection circuit 218, and the gating circuit 222. The rest of the configuration can be the same as the pixel signal processor 103 shown in FIG. 5.

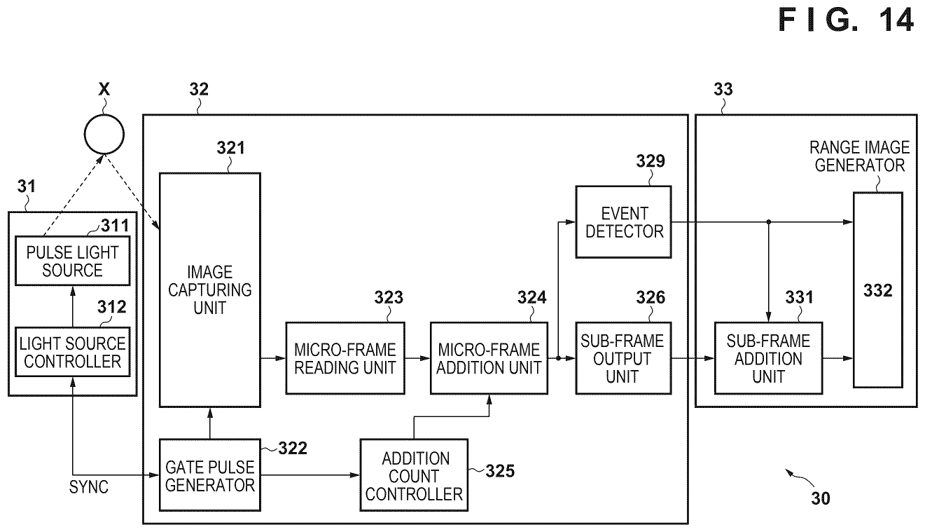

FIG. 14 is a functional block diagram showing an example of the schematic configuration of the range image generation device 30 according to this embodiment. The configuration of the light receiving device 32 is different from the configuration shown in FIG. 7. On the other hand, the configurations of the light emitting device 31 and the signal processing circuit 33 may be the same.

As for the image capturing unit 321, the configuration described with reference to FIGS. 12 and 13 is different from the image capturing unit 321 shown in FIG. 7, and only one type of signal can be output from one pixel 101. Also, the light receiving device 32 according to this embodiment can simultaneously acquire only one type micro-frames F3 for each pixel, and does not include the micro-frame reading unit 327 and the micro-frame addition unit 328. That is, it is impossible to perform the detection operation and the event detection operation described above in parallel.

The gate pulse generator 322, the micro-frame reading unit 323, the micro-frame addition unit 324, the addition count controller 325, the sub-frame output unit 326, and the event detector 329 are the same as in the configuration shown in FIG. 7. On the other hand, processing to be executed is different. More specifically, the event detector 329 acquires a signal of an event detection operation for event detection from the micro-frame addition unit 324.

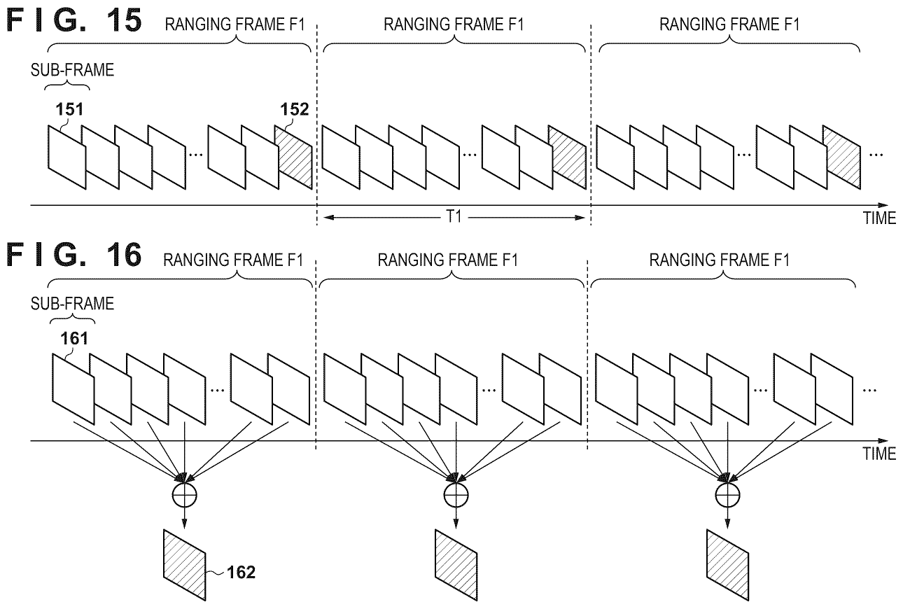

FIG. 15 is a timing chart for explaining the relationship between a ranging frame, a sub-frame, and an event detection frame obtained by the event detection operation according to this embodiment. A sub-frame 151 is one sub-frame F2 acquired in one sub-frame period T2 shown in FIG. 9, and the number of sub-frames F2 in one ranging frame F1 corresponds to the number of ranging points. In this embodiment, since an event detection frame 152 is acquired from the micro-frame addition unit 324, the gate pulse control method of the gate pulse generator 322 is different.

For the sub-frame 151 to perform the detection operation for generating a range image, the gate pulse G01 at “P_G1” shown in FIG. 8 is input to the gating circuit 216. After the sub-frames 151 as many as the number of ranging points are acquired, the gate pulse G02 at “P_G2” is input to the gating circuit 216, like the gate pulse G01. The gate pulses G01 and G02 are thus time-divisionally input, thereby acquiring the sub-frames 151 and the event detection frame 152 for range image generation. It can be said that each ranging frame period T1 includes a period in which the detection operation is performed to acquire a plurality of sub-frames 151, and a period in which the event detection operation is performed (a period in which the event detection frame 152 is acquired).

In this embodiment, an example in which one event detection frame 152 is acquired at the end of acquisition of the plurality of sub-frames 151 in one ranging frame period T1 has been described, but the present disclosure is not limited to this. Detecting an event by the event detector 329 using the event detection frame 152 suffices. For example, a plurality of event detection frames may be acquired in one ranging frame period T1. The event detection frame can be acquired at any position (timing) in the sub-frames 151 for range image generation.

As described above, in this embodiment, it is possible to obtain the same effect as the above-described embodiment while reducing the circuit configuration of the light receiving device 32. That is, the range image generation device 30 can improve both the frame rate and the ranging accuracy.

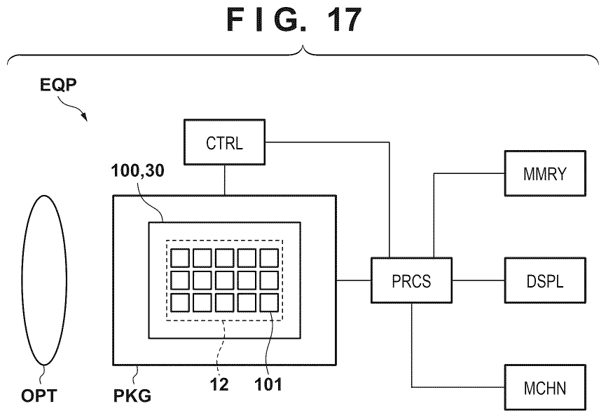

Another example of acquisition of the event detection frame will be described next with reference to FIG. 16. FIG. 16 is a timing chart for explaining the relationship between a ranging frame, a sub-frame, and an event detection frame obtained by the event detection operation according to this embodiment. A sub-frame 161 is one sub-frame F2 acquired in one sub-frame period T2 shown in FIG. 9, and the number of sub-frames F2 in one ranging frame F1 corresponds to the number of ranging points. In the configuration shown in FIG. 16, an event detection frame 162 is generated from the sub-frames 161 for range image generation. The event detector 329 reads out the sub-frame 161 for which addition of the micro-frames F3 is completed from the memory of the micro-frame addition unit 324 and holds it in the memory of the event detector 329. Every time the sub-frame 161 is read out, the event detector 329 sequentially adds the value of the sub-frame 161 to the value held in the memory. The sub-frames 161 as many as the number of ranging points are added and composited, thereby generating one event detection frame 162. The event detector 329, for example, compares the event detection frame 162 corresponding to a certain ranging frame period T1 with the event detection frame 162 corresponding to the immediately preceding ranging frame period T1, thereby detecting an event. It can be said that the event detector 329 detects a change (event) of the signal value of each pixel 101 based on data obtained by compositing the plurality of sub-frames 161 in each ranging frame period T1. In this embodiment, the event detector 329 is configured to hold two or more event detection frames 162 obtained by adding and compositing the sub-frames 161 as many as the number of ranging points.

As described above, in this embodiment, the event detection frame 162 is generated from the sub-frames 161 for range image generation. In a low-illuminance environment such as a darkroom where it is hard to capture an image by normal image capturing, the sub-frame 161 for range image generation is generated by detecting reflected light of laser light emission. Since the event detection frame 162 is generated from the plurality of sub-frames 161, an effect of reducing noise in event detection can be obtained.

An application example of the range image generation device 30 according to the above-described embodiment will be described below. FIG. 17 is a schematic view of equipment EQP with the range image generation device 30 mounted thereon. FIG. 17 shows the photoelectric conversion device 100 (image capturing unit 321) of the range image generation device 30. As described above, the photoelectric conversion device 100 can be a semiconductor chip having a stacked structure, in which the pixel region 12 with the pixels 101 arranged is provided. As shown in FIG. 17, the photoelectric conversion device 100 is stored in a semiconductor package PKG. The package PKG can include a base on which the photoelectric conversion device 100 is fixed, a lid body of glass or the like facing the photoelectric conversion device 100, and conductive connecting members such bonding wires and bumps, which connect terminals provided on the base and terminals provided on the photoelectric conversion device 100. The equipment EQP may further include at least one of a control device CTRL, a processing device PRCS, a display device DSPL, and a storage device MMRY. The package PKG in which the photoelectric conversion device 100 is stored may store not only the photoelectric conversion device 100 but also other components of the light receiving device 32 including the photoelectric conversion device 100 (image capturing unit 321) or the signal processing circuit 33. Also, the light emitting device 31 may also be stored in the package PKG. However, the present disclosure is not limited to this and, for example, the light emitting device 31 may be arranged independently of the package PKG.

An optical system OPT forms an image on the pixel region 12 and can be, for example, a lens, a shutter, or a mirror. The control device CTRL controls the operation of the range image generation device 30 and can be, for example, a semiconductor device such as an ASIC. The processing device PRCS processes a signal output from the range image generation device 30 and can be a semiconductor device such as a CPU or an ASIC. The display device DSPL can be an EL display device or a liquid crystal display device, which displays data obtained by the range image generation device 30. The storage device MMRY can be a magnetic device or a semiconductor device, which stores data obtained by the range image generation device 30. The storage device MMRY can be a volatile memory such as an SRAM or a DRAM, or a nonvolatile memory such as a flash memory or a hard disk drive. A mechanical device MCHN can include a movable portion or a propulsion portion such as a motor or an engine. Also, the mechanical device MCHN drives the components of the optical system OPT for, for example, zooming, focusing, or a shutter operation. The equipment EQP displays data output from the range image generation device 30 on the display device DSPL or transmits the data to the outside by a communication device (not shown) provided in the equipment EQP. Hence, the equipment EQP may include the storage device MMRY or the processing device PRCS.

The equipment EQP incorporating the range image generation device 30 can be applied to a monitor camera, or an in-vehicle camera mounted on transport equipment such as an automobile, a railway vehicle, a ship, an aircraft, or an industrial robot. In addition, the equipment EQP incorporating the range image generation device 30 can be applied not only to the transport equipment but also to equipment broadly using object recognition, such as an Intelligent Transport System (ITS).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-096899, which was filed on Jun. 14, 2024, and which is hereby incorporated by reference herein in its entirety.

What is claimed is:

1. A range image generation device comprising a plurality of pixels each including a photoelectric conversion element, and an image generator configured to generate a range image based on outputs from the plurality of pixels in each of a plurality of ranging frame periods,
wherein in each ranging frame period, a plurality of sub-frames are acquired by a plurality of detection operations in which time from a light emission timing of a light source until an exposure period for detecting light in the photoelectric conversion element is different,
the range image generation device further comprises an event detector configured to detect, for each of the plurality of pixels, a change of a signal value in at least two ranging frame periods of the plurality of ranging frame periods,
in each ranging frame period, for a pixel for which the change is detected by the event detector, the image generator is configured to acquire a pixel value of a range image based on the plurality of sub-frames, and
in each ranging frame period, for a pixel for which no change is detected by the event detector, the image generator is configured not to acquire a pixel value of the range image, or is configured to acquire the pixel value of the range image based on the plurality of sub-frames if a set condition is satisfied.

2. The device according to claim 1, wherein in each ranging frame period, for the pixel for which the change is detected by the event detector, the image generator is configured to acquire the pixel value of the range image based on the plurality of sub-frames in a ranging frame period in which the change is detected by the event detector.

3. The device according to claim 1, further comprising a sub-frame addition unit configured to hold the plurality of sub-frames of the pixel for which no change is detected by the event detector in each ranging frame period, and if the event detector does not detect the change in continuous ranging frame periods, add the plurality of sub-frames in the continuous ranging frame periods, which are held for each pixel,
wherein in each ranging frame period, for the pixel for which no change is detected by the event detector, the image generator is configured to acquire the pixel value of the range image based on data added by the sub-frame addition unit if the event detector does not detect the change in a predetermined number of continuous ranging frame periods.

4. The device according to claim 3, wherein if the image generator acquires the pixel value of the range image based on the data added by the sub-frame addition unit, the sub-frame addition unit is configured to reset the held data of the pixel whose pixel value is acquired.

5. The device according to claim 1, further comprising a sub-frame addition unit configured to hold the plurality of sub-frames in a predetermined number of latest ranging frame periods of the plurality of ranging frame periods and add the plurality of sub-frames in each of the predetermined number of ranging frame periods, which are held for each pixel,
wherein in each ranging frame period, for the pixel for which the change is detected by the event detector, the image generator is configured to acquire the pixel value of the range image based on data added by the sub-frame addition unit, and
in each ranging frame period, for the pixel for which no change is detected by the event detector, the image generator is configured not to acquire the pixel value of the range image.

6. The device according to claim 1, wherein
in each ranging frame period, an event detection operation of acquiring a signal from the photoelectric conversion element in an exposure period whose length is different from the exposure period of each of the plurality of detection operations is performed, and
the event detector is configured to detect the change of the signal value of each pixel based on the signal obtained by the event detection operation.

7. The device according to claim 6, further comprising a first reading unit configured to read out signals of the plurality of detection operations, and a second reading unit configured to read out a signal of the event detection operation,
wherein the plurality of detection operations and the event detection operation are performed in parallel.

8. The device according to claim 6, wherein each ranging frame period includes a period in which the plurality of detection operations are performed to acquire the plurality of sub-frames, and a period in which the event detection operation is performed.

9. The device according to claim 6, wherein the exposure period of the event detection operation is longer than the exposure period of each of the plurality of detection operations.

10. The device according to claim 1, wherein the event detector is configured to detect the change of the signal value of each pixel based on data obtained by compositing the plurality of sub-frames in each ranging frame period.

11. The device according to claim 1, further comprising a memory configured to store the pixel value of the range image,
wherein in each ranging frame period, for a pixel for which the pixel value of the range image is not acquired, the image generator is configured to use a pixel value in an immediately preceding ranging frame period for the range image.

12. The device according to claim 1, wherein the photoelectric conversion element includes an avalanche photodiode.

13. Equipment comprising:
the range image generation device according to claim 1; and
a processing device configured to process a signal output from the range image generation device.

14. The equipment according to claim 13, wherein, in the range image generation device, in each ranging frame period, for the pixel for which the change is detected by the event detector, the image generator is configured to acquire the pixel value of the range image based on the plurality of sub-frames in a ranging frame period in which the change is detected by the event detector.

15. The equipment according to claim 13,
wherein the range image generation device further comprises a sub-frame addition unit configured to hold the plurality of sub-frames of the pixel for which no change is detected by the event detector in each ranging frame period, and if the event detector does not detect the change in continuous ranging frame periods, add the plurality of sub-frames in the continuous ranging frame periods, which are held for each pixel,
wherein in each ranging frame period, for the pixel for which no change is detected by the event detector, the image generator is configured to acquire the pixel value of the range image based on data added by the sub-frame addition unit if the event detector does not detect the change in a predetermined number of continuous ranging frame periods.

16. The equipment according to claim 13,
wherein the range image generation device further comprises a sub-frame addition unit configured to hold the plurality of sub-frames in a predetermined number of latest ranging frame periods of the plurality of ranging frame periods and add the plurality of sub-frames in each of the predetermined number of ranging frame periods, which are held for each pixel,
wherein in each ranging frame period, for the pixel for which the change is detected by the event detector, the image generator is configured to acquire the pixel value of the range image based on data added by the sub-frame addition unit, and
in each ranging frame period, for the pixel for which no change is detected by the event detector, the image generator is configured not to acquire the pixel value of the range image.

17. The equipment according to claim 13, wherein, in the range image generation device,
in each ranging frame period, an event detection operation of acquiring a signal from the photoelectric conversion element in an exposure period whose length is different from the exposure period of each of the plurality of detection operations is performed, and
the event detector is configured to detect the change of the signal value of each pixel based on the signal obtained by the event detection operation.

18. The equipment according to claim 13, wherein, in the range image generation device, the event detector is configured to detect the change of the signal value of each pixel based on data obtained by compositing the plurality of sub-frames in each ranging frame period.

19. The equipment according to claim 13, the range image generation device further comprises a memory configured to store the pixel value of the range image,
wherein in each ranging frame period, for a pixel for which the pixel value of the range image is not acquired, the image generator is configured to use a pixel value in an immediately preceding ranging frame period for the range image.
